(19) United States
(12) Patent Application Publication
(10) Pub. No.: US 2012/0147467 A1
(43) Pub. Date: Jun. 14, 2012

(54) TOUCH SCREEN PANEL INTEGRATED WITH POLARIZER

(76) Inventor: Jung-Mok Park, Yongin-city (KR)

(21) Appl. No.: 13/181,427

(22) Filed: Jul. 12, 2011

(30) Foreign Application Priority Data
Dec. 13, 2010 (KR) 10-2010-0126948

(51) Int. Cl. G02B 5/30; G02B 1/08

(52) U.S. Cl. 359/488.01

(57) ABSTRACT

A touch screen panel integrated with a polarizer of, e.g., a display device, in which the touch screen panel is formed in the polarizer to reduce the thickness of the touch screen panel (or the overall display device). The touch screen panel integrated with the polarizer includes sensing patterns formed on one surface of a first supporting layer of a polarizer, an optical layer formed on the first supporting layer including the sensing patterns, and a second supporting layer formed on the optical layer.

### CROSS-REFERENCE TO RELATED APPLICATION

This application claims priority to and the benefit of Korean Patent Application No. 10-2010-0126948, filed on Dec. 13, 2010, in the Korean Intellectual Property Office, the entire content of which is incorporated herein by reference.

### BACKGROUND

1. Field

The following description relates to a touch screen panel, and more particularly, to a touch screen panel integrated with a polarizer.

2. Description of the Related Art

A touch panel is an input device capable of selecting the indication content displayed on the screen of an image display device by a human hand or an object to input the command of a user.

Therefore, the touch panel is provided on the front face of the image display device to convert a contact position of the human hand or the object into an electrical signal. Therefore, the instruction contact selected in the contact position is received as an input signal.

Since the touch panel may replace an additional input device coupled to the image display device to operate such as a keyboard and a mouse, the use range is gradually increasing.

When the touch screen panel is attached onto the top of the panel of the image display device, the volume of the display device increases so that the convenience of carriage may deteriorate. As such, there is a need for the development of a touch screen panel that is made thin.

In addition, a polarizer is attached onto the external surface of the image display device in order to improve outdoor visibility such as blocking of external light reflection. When the touch screen panel is attached onto the top of the panel of the image display device, the polarizer may be attached onto the external surface of the touch screen panel.

At this time, after separately manufacturing the polarizer and the touch screen panel, processes of attaching the polarizer and the touch screen panel to each other or of assembling the polarizer and the touch screen panel are to be performed. Therefore, the thickness of the touch screen panel (or the overall display device) increases, process efficiency is reduced, and yield is reduced.

### SUMMARY

An aspect of an embodiment of the present invention is directed toward a touch screen panel integrated with a polarizer of a display device, which is formed in the polarizer to reduce the thickness of the touch screen panel (or the overall display device).

In order to achieve the foregoing and/or other aspects of the present invention, according to an embodiment of the present invention, there is provided a touch screen panel integrated with a polarizer, including sensing patterns formed on one surface of a first supporting layer of a polarizer, an optical layer formed on the first supporting layer including the sensing patterns, and a second supporting layer formed on the optical layer.

In one embodiment, the sensing patterns include a plurality of first sensing patterns formed on the first supporting layer to be coupled along a first direction and a plurality of second sensing patterns formed under the second supporting layer, alternately arranged not to overlap the first sensing patterns, and coupled along a second direction.

In one embodiment, the first and second supporting layers are formed of a triacetyl cellulose (TAC) film. In one embodiment, the optical layer is formed of polyvinyl alcohol (PVA).

In one embodiment, the sensing patterns include a plurality of first sensing patterns formed to be coupled along a first direction and second sensing patterns formed (arranged) to have separate patterns positioned between the first sensing patterns.

In one embodiment, the touch screen panel integrated with the polarizer further includes a first insulating layer formed on the first and second sensing patterns and having a plurality of contact holes exposing one region of the second sensing patterns and a plurality of coupling patterns formed on the first insulating layer to couple the second sensing patterns through the contact holes along a second direction.

In one embodiment, the first and second supporting layers are formed of different materials. In one embodiment, the first supporting layer is formed of thin film enhanced glass or glass fiber compound, and the second supporting layer is formed of TAC film.

In one embodiment, the first and second sensing patterns are formed on the first supporting layer.

In one embodiment, the sensing patterns of the touch screen panel are formed on at least one surface of the first and second supporting layers that constitute the polarizer in order to realize the touch screen panel in the polarizer and so that the thickness of the touch screen panel including the polarizer (e.g., the overall display device) may be reduced.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a sectional view illustrating the structure of a polarizer;

FIG. 2 is a plan view schematically illustrating a touch screen panel integrated with a polarizer according to an embodiment of the present invention;

FIG. 3 is a sectional view illustrating the main part of the touch screen panel of FIG. 2;

FIG. 4 is a plan view schematically illustrating a touch screen panel integrated with a polarizer according to another embodiment of the present invention;

FIG. 5 is a sectional view illustrating the main part of the touch screen panel of FIG. 4; and

FIGS. 6A and 6B are sectional views illustrating the main part of a touch screen panel integrated with a polarizer according to still another embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the element or be indirectly on the element with one or more intervening elements interposed therebetween. Also, when an element is referred to as being “connected to” another element, it can be directly connected to the element or be indirectly connected to the element with one or more intervening elements interposed therebetween. Hereinafter, like reference numerals refer to like elements.

Hereinafter, the embodiments of the present invention will be described in detail with reference to the accompanying drawings.

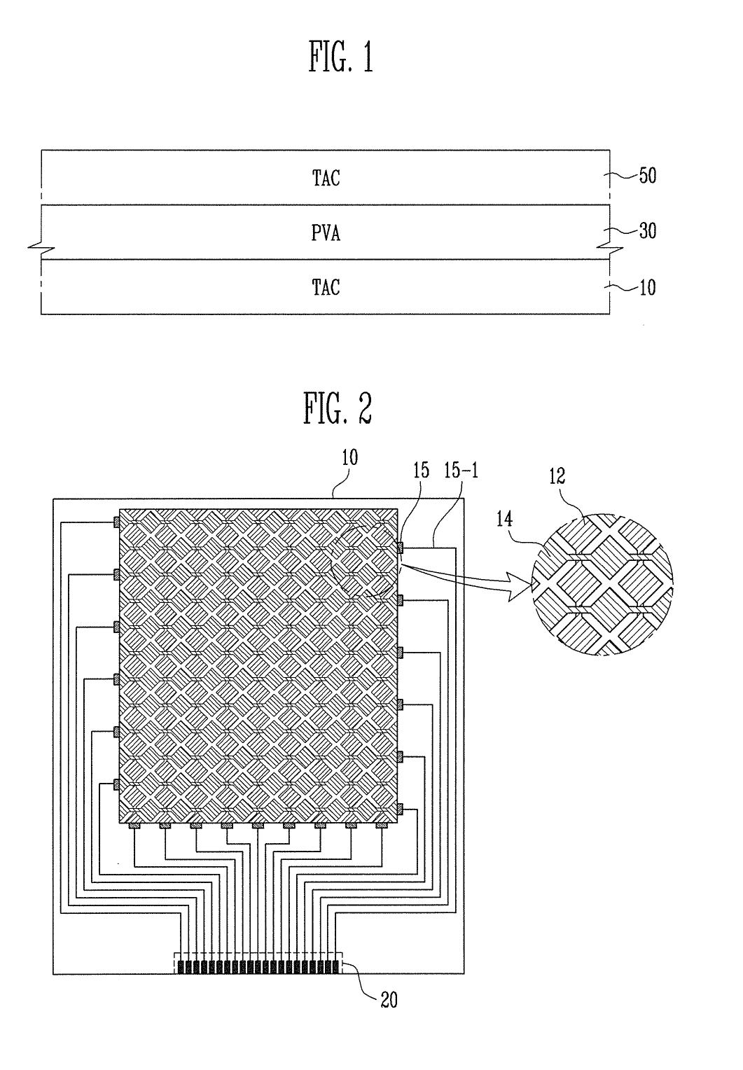

FIG. 1 is a sectional view illustrating the structure of a polarizer.

Referring to FIG. 1, in general, a polarizer has a structure in which an optical layer 30 is interposed between upper and lower supporting layers 10 and 50.

Here, the optical layer 30 for controlling the amount of light transmitted in accordance with the degree of polarization of incident light may be formed of a polyvinyl alcohol (PVA) film. In one embodiment, the optical layer 30 is formed by an elongated PVA film that absorbs iodine (which is a polarizer) by a strong tension to realize polarization.

In addition, the supporting layers 10 and 50 provided on and under the optical layer 30 may be formed of a triacetyl cellulose (TAC) film for protecting and supporting the PVA film. The elongated PVA film has contractility. The TAC film prevents the PVA film from being contracted.

The polarizer is commonly attached to the outside of the image display panel in order to improve outdoor visibility such as blocking of external light reflection. When the touch screen panel is attached onto the top of the panel of the image display device, the polarizer may be attached onto the external surface of the touch screen panel.

However, after separately manufacturing the polarizer and the touch screen panel, processes of attaching the polarizer and the touch screen panel to each other or of assembling the polarizer and the touch screen panel are to be performed. Therefore, the thickness of the touch screen panel (or the overall display device including the touch screen panel) increases, process efficiency is reduced, and yield is reduced.

In particular, in the case of the lamination structured polarizer, since the optical layer has a thickness of about 20 μm and the upper and lower supporting layers have a thickness of about 80 μm, the polarizer has a thickness of about 180 μm. When the polarizer is attached to the touch screen panel, the thickness of the touch screen panel is increased so that the touch screen panel is prevented from being made thin.

In a touch screen panel according to an embodiment of the present invention, the sensing patterns of the touch screen panel are formed with at least one surface of the supporting layers that constitute the polarizer to realize the touch screen panel in the polarizer. Therefore, the thickness of the touch screen panel including the polarizer may be reduced.

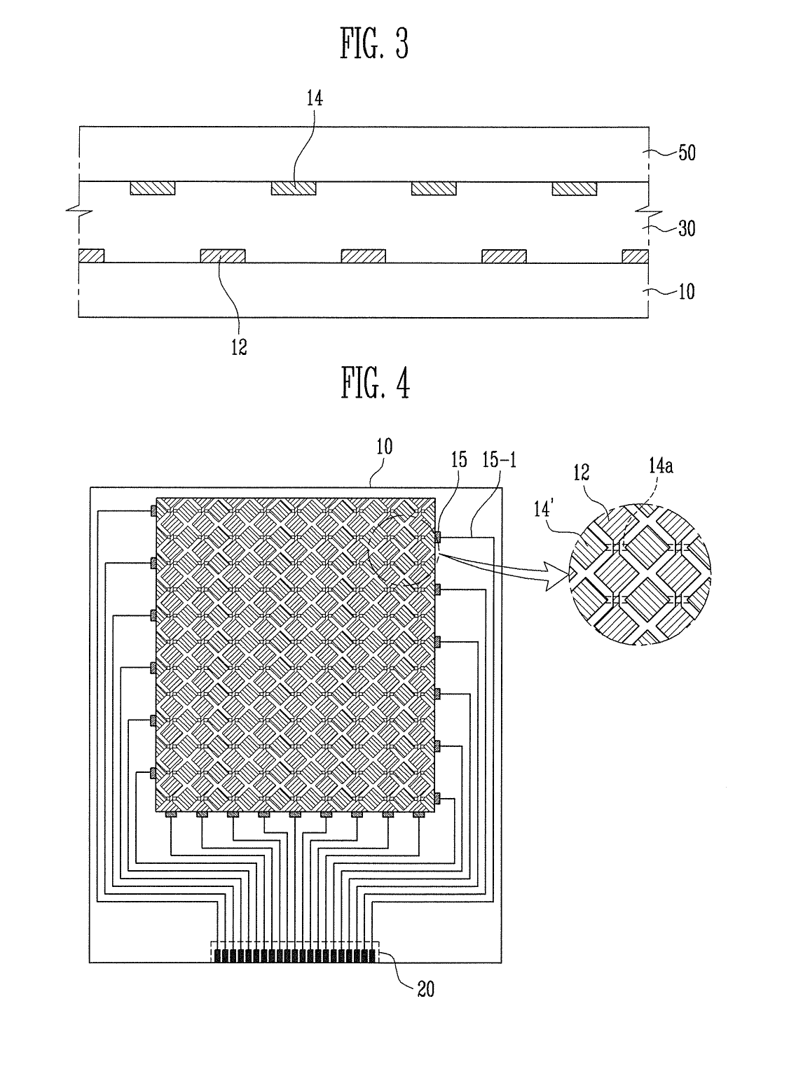

FIG. 2 is a plan view schematically illustrating a touch screen panel integrated with a polarizer according to an embodiment of the present invention. FIG. 3 is a sectional view illustrating the main part of the touch screen panel of FIG. 2.

Referring to FIGS. 2 and 3, the touch screen panel includes a plurality of first sensing patterns 12 formed on a first supporting layer 10 of a polarizer, an optical layer 30 formed on the first supporting layer 10 including the first sensing patterns 12, a plurality of second sensing patterns 14 formed under a second supporting layer 50 facing the first supporting layer 10 and alternately arranged not to overlap the first sensing patterns 12, and a plurality of metal patterns 15 for electrically coupling the first and second sensing patterns 12 and 14 to position detecting lines 15_1.

That is, in the embodiment illustrated in FIGS. 2 and 3, the two layer structured touch screen panel is integrally formed in the polarizer illustrated in FIG. 1.

The optical layer 30 is formed of polyvinyl alcohol (PVA). In the embodiment of the present invention, the optical layer 30 functions as a polarizer and a dielectric substance between the first and second sensing patterns 12 and 14.

In addition, the first and second supporting layers 10 and 50 are formed of a triacetyl cellulose (TAC) film.

The first and second sensing patterns 12 and 14 are alternately arranged so that the first sensing patterns 12 (e.g., the sensing patterns for X coordinates) in the same column and the second sensing patterns 14 (e.g., the sensing patterns for Y coordinates) in the same row are coupled to each other.

The sensing patterns 12 and 14 are formed to be attached to each other and are formed (or are each formed) to have a regular pattern such as a diamond pattern. On the other hand, the shape of the sensing patterns 12 and 14 are not limited to the diamond shape. The sensing patterns 12 and 14 may be realized in various suitable shapes where the sensing patterns 12 and 14 may be attached to each other.

According to the present invention, the first sensing patterns 12 formed to be coupled in a first direction and the second sensing patterns 14 formed to be coupled in a second direction that intersect (cross) the first direction are respectively formed on surfaces of different layers, that is, the first sensing patterns 12 on the first supporting layer 10 and the second sensing patterns 14 on (under) the second supporting layer 50 are formed with the optical layer 30 interposed therebetween.

Therefore, the first sensing patterns 12 are formed on the first supporting layer 10 to be coupled in the first direction, for example, in a column direction. That is, the first sensing patterns 12 may be formed of a plurality of X patterns so that a plurality of patterns, in which the sensing patterns for X coordinates are positioned in the same column, are coupled to each other.

On the other hand, the first sensing patterns 12 are not limited to the X patterns. For example, the first sensing patterns 12 may be formed of a plurality of Y patterns formed so that a plurality of patterns, in which the sensing patterns for Y coordinates are positioned in the same row, are coupled to each other. For convenience sake, hereinafter, the first sensing patterns 12 and the second sensing patterns 14 are assumed as the X patterns and the Y patterns.

The first sensing patterns 12 are coupled to the position detecting lines 15_1 in units of columns by metal patterns 15.

In addition, the second sensing patterns 14 are formed under the second supporting layer 50 facing the first supporting layer 10 and are alternately arranged not to overlap the first sensing patterns.

Here, the second sensing patterns 14 are formed to be coupled in the second direction that intersect (cross) the first direction, for example, in a row direction. That is, when the first sensing patterns 12 are formed to be the X patterns, the second sensing patterns 14 may be formed to be the plurality of Y patterns so that the plurality of patterns, in which the patterns for the Y coordinates are positioned in the same row, are coupled to each other.

The second sensing patterns 14 are coupled to the position detecting lines 15_1 in units of rows by the metal patterns 15.

The metal patterns 15 are coupled to the first and second sensing patterns 12 and 14 at the edge of the region in which the first and second sensing patterns 12 and 14 are positioned to electrically couple the first and second sensing patterns 12 and 14 to the position detecting lines 15_1.

For example, the metal patterns 15 electrically couple the first sensing patterns 12 in units of one column to the respective position detecting lines 15_1 and electrically couple the second sensing patterns 14 in units of one row to the respective position detecting lines 15_1.

The position detecting lines 15_1 are coupled to the first and second sensing patterns 12 and 14 through the metal patterns 15 to couple the first and second sensing patterns 12 and 14 to a driving circuit. For example, when the touch screen panel is coupled to an external driving circuit through a pad unit 20, the position detecting lines 15_1 are coupled between the pad unit 20 and the sensing patterns 12 and 14.

On the other hand, in the above description, the metal patterns 15 and the position detecting lines 15_1 are described as additional components. However, the present invention is not limited to the above. For example, the metal patterns 15 and the position detecting lines 15_1 may be formed of the same material to be integrated with each other in the same process.

The above-described touch screen panel is an electrostatic capacitive touch screen panel. When a contact object such as a human hand or a touch stick contacts the touch screen panel, a change in electrostatic capacity in accordance with a contact position is transmitted from the sensing patterns 12 and 14 to the driving circuit via the metal patterns 15, the position detecting lines 15_1, and the pad unit 20. The change in the electrostatic capacity is converted into an electric signal by an X and Y input processing circuit so that the contact position is sensed.

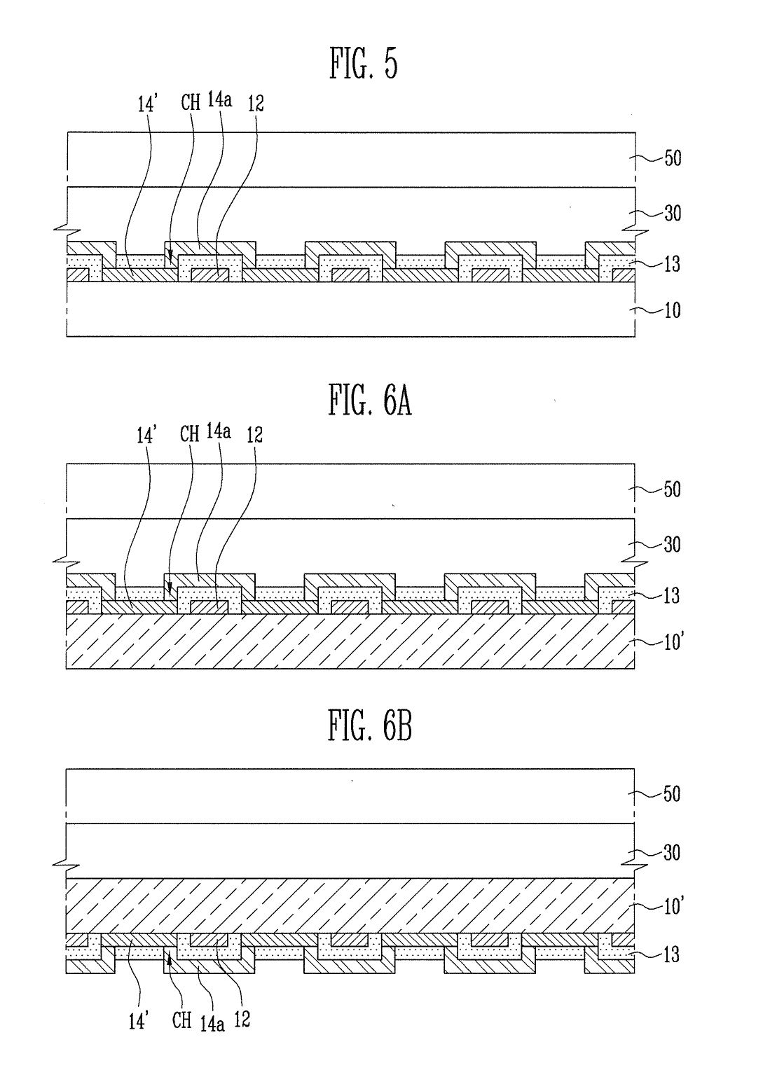

FIG. 4 is a plan view schematically illustrating a touch screen panel integrated with a polarizer according to another embodiment of the present invention. FIG. 5 is a sectional view illustrating the main part of the touch screen panel of FIG. 4.

A difference between the embodiment illustrated in FIGS. 4 and 5 and the embodiment illustrated in FIGS. 2 and 3 is that second sensing patterns 14′ are not formed under the second supporting layer 50, but are formed in the same layer as the first sensing patterns 1, that is, on (e.g., directly on) the first supporting layer 10.

Therefore, the same elements as the embodiment illustrated in FIGS. 2 and 3 are denoted by the same reference numerals and detailed description thereof will be omitted.

Referring to FIGS. 4 and 5, the touch screen panel according to another embodiment of the present invention includes a plurality of first and second sensing patterns 12 and 14′ formed on (e.g., directly on) the first supporting layer 10 of a polarizer, the optical layer 30 formed on the first supporting layer 10 including the first and second sensing patterns 12 and 14′, the second supporting layer 50 formed on the optical layer 30 to face the first supporting layer 10, and the plurality of metal patterns for electrically coupling the first and second sensing patterns 12 and 14′ to the position detecting lines 15_1.

Here, the second sensing patterns 14′ are formed on the same plane as the first sensing patterns 12 and are alternately arranged not to overlap the first sensing patterns 12.

That is, in the embodiment illustrated in FIGS. 4 and 5, a one layer structured touch screen panel is integrally formed in the polarizer illustrated in FIG. 1.

Therefore, the optical layer 30 is formed of polyvinyl alcohol (PVA) and the first and second supporting layers 10 and 50 are realized by a triacetyl cellulose (TAC) film.

According to the above embodiment, the second sensing patterns 14′ are arranged in the same layer as the first sensing patterns 12 and are formed so that the second sensing patterns 14′ have separate patterns positioned between the first sensing patterns 12. The second sensing patterns 14′ may be formed to be electrically coupled in a second direction by additional coupling patterns 14a. For example, the second sensing patterns 14′ are formed as independent patterns in a patterning process, and the patterns positioned in the same row may be coupled in an X axis direction by the coupling patterns 14a in subsequent processes.

Therefore, referring to FIG. 5, an insulating layer 13 is formed on the first and second sensing patterns 12 and 14′, and a plurality of contact holes CH exposing one region of the second sensing patterns 14′ are formed in the insulating layer 13. The coupling patterns 14a are formed on the insulating layer 13 to electrically couple the second sensing patterns 14′ through the contact holes CH formed in the insulating layer 13 in the second direction.

Then, as illustrated above, the optical layer 30 and the second supporting layer 50 are sequentially attached onto the insulating layer 13 including the coupling patterns 14a so that the touch screen panel integrated with the polarizer according to the embodiment of the present invention is realized.

According to the above-described embodiment, the sensing patterns 12 and 14′ that constitute the touch screen panel are formed on the supporting layer 10 that constitutes the polarizer. In this case, due to the heat resistant characteristic and the hardness of the supporting layer 10 in which the sensing patterns 12 and 14′ are formed, that is, the TAC film, productivity deteriorates.

According to another embodiment of the present invention, in order to solve the above disadvantage, the first supporting layer 10, in which the sensing patterns 12 and 14′ are formed between the first and second supporting layers 10 and 50 of the polarizer, is formed of a different material from the second supporting layer 50, that is, thin film enhanced glass or glass fiber compound having secured heat resistance.

In this case, like in the embodiment illustrated in FIGS. 4 and 5, the one layer structured touch screen panel is integrally formed in the polarizer.

FIGS. 6A and 6B are sectional views illustrating the main part of a touch screen panel integrated with a polarizer according to still another embodiment of the present invention.

In the embodiment of FIGS. 6A and 6B, since a plan view is the same as the embodiment illustrated in FIG. 4, the plan view is omitted. In comparison with the embodiment of FIG. 5, since the structure is the same excluding that the material of the first supporting layer is different, the same elements are denoted by the same reference numerals and description thereof will be omitted.

First, in the embodiment illustrated in FIG. 6A, a touch screen panel includes the plurality of first and second sensing patterns 12 and 14′ formed on a first supporting layer 10′ of a polarizer, the optical layer 30 formed on the first supporting layer 10′ including the first and second sensing patterns 12 and 14′, the second supporting layer 50 formed on the optical layer 30 to face the first supporting layer 10′, and the plurality of metal patterns 15 for electrically coupling the first and second sensing patterns 12 and 14′ to the position detecting lines 15_1.

In addition, in the embodiment illustrated in FIG. 6B, the first and second sensing patterns 12 and 14′ and the metal patterns 15 are not formed on the first supporting layer 10′, but are formed under the first supporting layer 10′. The other structures are the same as the structures of the embodiment of FIG. 6A.

Here, the second sensing patterns 14′ are formed on the same plane as the first sensing patterns 12 and are alternately arranged not to overlap the first sensing patterns 12. The one layer structured touch screen panel is integrally formed in the polarizer illustrated in FIG. 1.

In the embodiment of FIGS. 6A and 6B, the first supporting layer 10′ of the polarizer, in which the first and second sensing patterns 12 and 14′ are formed, is not formed of the TAC film, but is formed of the thin film enhanced glass or the glass fiber compound.

The second supporting layer 50 is formed of the TAC film like in the above-described embodiment. Therefore, according to the embodiment of the present invention, the first supporting layer 10′ and the second supporting layer 50 are formed of different materials.

The thin film enhanced glass or the glass fiber compound used as the first supporting layer 10′ has no refractive index anisotropy and has secured characteristics of heat resistance and surface hardness (e.g., characteristics that are relatively high). Therefore, although the sensing patterns are formed on the first supporting layer 10′, productivity improves.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A touch screen panel integrated with a polarizer, comprising:
a plurality of sensing patterns on one surface of a first supporting layer of the polarizer;
an optical layer on the first supporting layer with the sensing patterns; and
a second supporting layer on the optical layer.

2. The touch screen panel integrated with the polarizer as claimed in claim 1, wherein the sensing patterns comprise:
a plurality of first sensing patterns on the first supporting layer and coupled along a first direction, and
a plurality of second sensing patterns under the second supporting layer, alternately arranged not to overlap the first sensing patterns, and coupled along a second direction.

3. The touch screen panel integrated with the polarizer as claimed in claim 2, wherein the first and second supporting layers are formed of a triacetyl cellulose (TAC) film.

4. The touch screen panel integrated with the polarizer as claimed in claim 1, wherein the optical layer is formed of polyvinyl alcohol (PVA).

5. The touch screen panel integrated with the polarizer as claimed in claim 1, wherein the sensing patterns comprise:
a plurality of first sensing patterns coupled along a first direction; and
a plurality of second sensing patterns arranged to have separate patterns positioned between the first sensing patterns.

6. The touch screen panel integrated with the polarizer as claimed in claim 5, further comprising:
a first insulating layer on the first and second sensing patterns and having a plurality of contact holes exposing one region of the second sensing patterns; and
a plurality of coupling patterns on the first insulating layer to couple the second sensing patterns through the contact holes along a second direction.

7. The touch screen panel integrated with the polarizer as claimed in claim 5, wherein the first and second supporting layers are formed of a TAC film.

8. The touch screen panel integrated with the polarizer as claimed in claim 5, wherein the first and second supporting layers are formed of different materials.

9. The touch screen panel integrated with the polarizer as claimed in claim 8,
wherein the first supporting layer is formed of thin film enhanced glass or glass fiber compound, and
wherein the second supporting layer is formed of TAC film.

10. The touch screen panel integrated with the polarizer as claimed in claim 9, wherein the first and second sensing patterns are under the first supporting layer.

11. The touch screen panel integrated with the polarizer as claimed in claim 5, wherein the first and second sensing patterns are on the first supporting layer.

12. The touch screen panel integrated with the polarizer as claimed in claim 5, wherein the first and second sensing patterns are under the first supporting layer.
